(19) United States
(12) Patent Application Publication
(10) Pub. No.: US 2009/0141749 A1
(43) Pub. Date: Jun. 4, 2009

(54) LASER MODULE

(75) Inventors: Shang-Yi WU, Hsinchu (TW); Ching-Lun LIN, Hsinchu (TW)

Correspondence Address: J C PATENTS, INC., 4 VENTURE, SUITE 250, IRVINE, CA, 92618, US

(73) Assignee: YOUNG OPTICS INC., Hsinchu (TW)

(21) Appl. No.: 11/949,194

(22) Filed: Dec. 3, 2007

(51) Int. Cl. H01S 3/10

(52) U.S. Cl. 372/22

(57) ABSTRACT

A laser module including a light emitter, a filter, a nonlinear optical crystal, a first temperature adjuster, and a second temperature adjuster is provided. The light emitter emits a first beam. The filter is disposed on a transmission path of the first beam and reflects the first beam. The nonlinear optical crystal is disposed on the transmission path of the first beam and between the light emitter and the filter. The nonlinear optical crystal converts a part of the first beam into a second beam. A frequency of the second beam is larger than a frequency of the first beam. The second beam passes through the filter. The first temperature adjuster is connected with the filter for adjusting a temperature of the filter. The second temperature adjuster is connected with the nonlinear optical crystal for adjusting a temperature of the nonlinear optical crystal.

### BACKGROUND OF THE INVENTION

1. Field of the Invention

The present invention relates to a light source module. More particularly, the present invention relates to a laser module.

2. Description of Related Art

Referring to FIG. 1, a conventional Novalux extended cavity surface emitting laser (NECSEL) 100 includes a light emitter 110, a volume Bragg grating (VBG) 120 and a periodically poled lithium niobate crystal (PPLN crystal) 130. The light emitter 110 includes a light emitting layer 112, a p-type distributed Bragg reflector (DBR) 114 and an n-type DBR 116. The p-type DBR 114 and the n-type DBR 116 are disposed on two opposite sides of the light emitting layer 112, respectively. The light emitting layer 112 is capable of emitting an initial infrared (IR) beam 112i. The initial IR beam 112i passes through the n-type DBR 116, passes through the PPLN crystal 130, is reflected by the VBG 120, returns to the PPLN crystal 130, passes through the PPLN crystal 130, passes through the n-type DBR 116, passes through the light emitting layer 112, and is reflected by the p-type DBR 114 in sequence. The p-type DBR 114 and the VBG 120 form an internal cavity C therebetween. After the initial IR beam 112i is reflected within the internal cavity C many times, the light emitting layer 112 generates stimulated emission and emits an IR beam 112a with coherence, and the IR beam 112a resonates within the internal cavity C. When passing through the PPLN crystal 130, a part of the IR beam 112a is converted into a visible beam 112b by the PPLN crystal 130. The visible beam 112b with coherence is then pass through the VBG 120 and travels outward.

In the NECSEL 100, the transmission and reflection spectra of the VBG 120 are varied with the temperature of the VGB 120, and the wavelength corresponding to the maximum of beam conversion ratios of the PPLN crystal 130 is varied with the temperature of the PPLN crystal 130. Therefore, the temperature of the VBG 120 and the temperature of the PPLN crystal 130 preferably match each other. Otherwise, the proportion of the beam conversion from the IR beam 112a into the visible beam 112b of the PPLN crystal 130 will decrease because the wavelength of the IR beam 112a reflected by the VBG 120 deviates away from the wavelength corresponding to the maximum of beam conversion ratios of the PPLN crystal 130 at the temperature at that time. When the NECSEL 100 is in operation, the temperature of the VBG 120 is increased by absorbing a part of energy of the visible beam 112b or changed with the environment temperature, which causes the temperature mismatch between the VBG 120 and the PPLN crystal 130, so as to reduce the proportion of the visible beam 112b converted from the IR beam 112a, the output power of the visible beam 112b, and the output power of the NECSEL 100.

### SUMMARY OF THE INVENTION

The present invention is directed to a laser module, which has high output power.

Other advantages of the present invention can be further understood from the technical features disclosed by the present invention.

An embodiment of the present invention provides a laser module including a light emitter, a filter, a nonlinear optical crystal, a polarizing and filtering element, a first temperature adjuster and a second temperature adjuster. The light emitter is capable of emitting a first beam. The filter is disposed on a transmission path of the first beam and capable of reflecting the first beam. The nonlinear optical crystal is disposed on the transmission path of the first beam and between the light emitter and the filter. The nonlinear optical crystal is capable of converting a part of the first beam into a second beam. A frequency of the second beam is larger than a frequency of the first beam. The filter is capable of being passed through by the second beam. The polarizing and filtering element is disposed on the transmission path of the first beam and between the light emitter and the nonlinear optical crystal. The polarizing and filtering element is capable of being passed through by at least a part of the first beam with a specific polarization direction and reflecting the second beam. The first temperature adjuster is connected with the filter for adjusting a temperature of the filter. The second temperature adjuster is connected with the nonlinear optical crystal for adjusting a temperature of the nonlinear optical crystal.

Another embodiment of the present invention also provides a laser module in which a temperature adjuster is connected with both the filter and the nonlinear optical crystal for adjusting temperatures of both the filter and the nonlinear optical crystal.

In the laser module, both the temperature of the filter and the temperature of the nonlinear optical crystal are adjusted to match each other when the laser module is in operation, such that the laser module provides the second beam with higher power.

Other objectives, features and advantages of the present invention will be further understood from the further technology features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic structural view of a conventional Novalux extended cavity surface emitting laser.

FIG. 2 is a schematic structural view of a laser module according to an embodiment of the present invention.

FIGS. 3 and 4 show the experimental data of the laser module in FIG. 2.

FIG. 5 is a schematic structural view of a laser module according to another embodiment of the present invention.

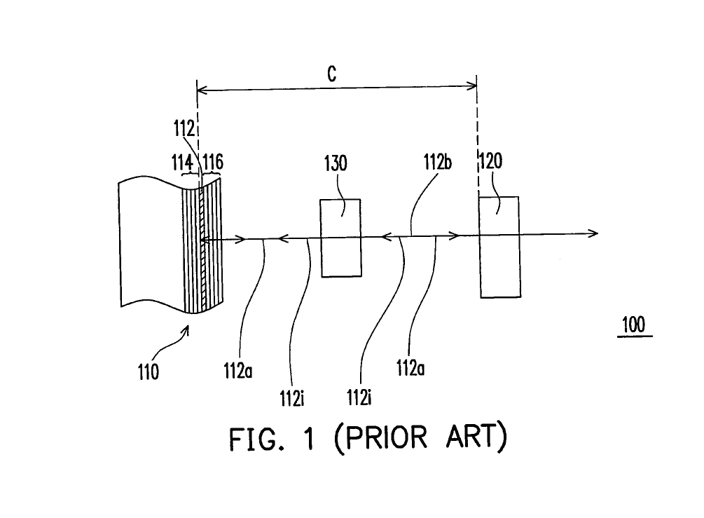

### DESCRIPTION OF EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

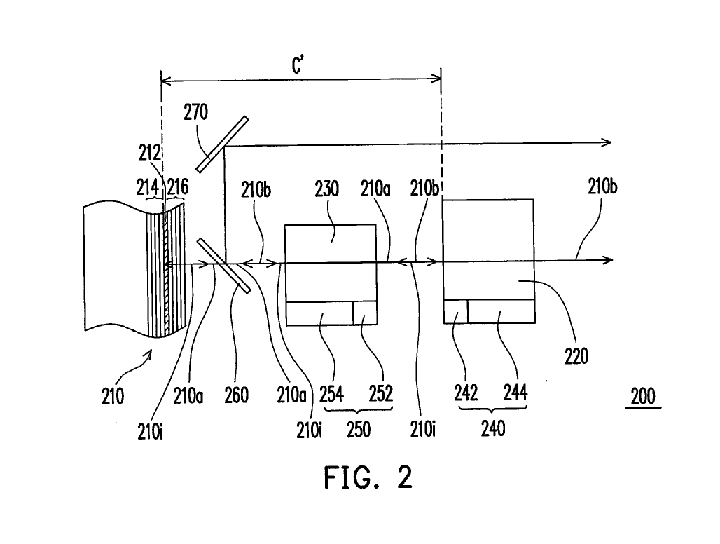

Referring to FIG. 2, a laser module 200 according to an embodiment of the present invention includes a light emitter 210, a filter 220, a nonlinear optical crystal 230, a polarizing and filtering element 260, a first temperature adjuster 240 and a second temperature adjuster 250. In the present embodiment, the light emitter 210 includes a light emitting layer 212, a reflecting unit 214 and a partially transmitting and partially reflecting unit 216. When the light emitter 210 is starting to work, the light emitting layer 212 emits an initial beam 210i. Then, a part of the initial beam 210i passes through the partially transmitting and partially reflecting unit 216, passes through the nonlinear optical crystal 230, is reflected by the filter 220, passes through the nonlinear optical crystal 230 again, passes through the partially transmitting and partially reflecting unit 216 again, passes through the light emitting layer 212, is reflected by the reflecting unit 214, and passes through the light emitting layer 212 again in sequence. After the initial beam 210i is reflected between the reflecting unit 216 and the filter 220 many times, the light emitting layer 212 generates stimulated emission and emits a first beam 210a with coherence, such that the light emitter 210 is capable of emitting a first beam 210a with coherence.

The filter 220 is disposed on a transmission path of the first beam 210a. The nonlinear optical crystal 230 is disposed on the transmission path of the first beam 210a and between the light emitter 210 and the filter 220. In the present embodiment, both the reflecting unit 214 and the partially transmitting and partially reflecting unit 216 are, for example, distributed Bragg reflectors (DBRs). The reflecting unit 214 is disposed on one side of the light emitting layer 212 for reflecting the first beam 210a. The partially transmitting and partially reflecting unit 216 is disposed on another side of the light emitting layer 212 opposite to the reflecting unit 214 and on the transmission path of the first beam 210a between the light emitting layer 212 and the nonlinear optical crystal 230. In addition, a part of the first beam 210a is reflected between the reflecting unit 214 and the partially transmitting and partially reflecting unit 216, and the other part passes through the partially transmitting and partially reflecting unit 216 and travels to the nonlinear optical crystal 230.

The nonlinear optical crystal 230 is capable of converting a part of the first beam 210a into a second beam 21b. The frequency of the second beam 210b is larger than the frequency of the first beam 210a. In other words, the wavelength of the second beam 210b is smaller than the wavelength of the first beam 210a. In the present invention, the nonlinear optical crystal 230 is, for example, a periodically poled lithium niobate (PPLN) crystal, a periodically poled potassium titanyl phosphate crystal (PPKTP crystal), or other nonlinear optical crystals. In the present invention, the frequency of the second beam 210b is double the frequency of the first beam 210a. In other words, the wavelength of the second beam 210b is half the wavelength of the first beam 210a. More particularly, the first beam 210a is, for example, an IR beam, and the second beam 210b is, for example, a visible beam.

The filter 220 is capable of being passed through by the second beam 210b, and capable of reflecting the first beam 210a. In the present embodiment, the filter 220 is, for example, a volume Bragg grating (VBG). However, in other embodiments, the filter may be a notch filter or other appropriate filter. More particularly, the filter 220 is capable of being passed through by a visible beam (i.e. the second beam 210b), and capable of reflecting an IR beam (i.e. the first beam 210a), for example. As such, the first beam 210a resonates in an internal cavity C′ formed between the reflecting unit 214 and the filter 220. In addition, the second beam 210b with coherence converted from the first beam 210a with coherence passes through the filter 220 and travels outward.

The polarizing and filtering element 260 disposed on the transmission path of the first beam 210a and between the light emitter 210 and the nonlinear optical crystal 230. The polarizing and filtering element 260 has both a polarizing function and a color filtering function. The polarizing and filtering element 260 is capable of being passed through by a beam within a specific wavelength range, for example, the infrared range, and with a specific polarization direction, for example, a p-polarization direction. Additionally, the polarizing and filtering element 260 is capable of reflecting a beam within another specific wavelength range, for example, the visible range. As such, the polarizing and filtering element 260 is passed through by at least a part of the first beam 210a with the p-polarization direction and reflects the second beam 210b from the nonlinear optical crystal 230. In this way, the second beam 210b from the nonlinear optical crystal 230 may be utilized.

In the present embodiment, the laser module 200 further includes a reflector 270 disposed on the transmission path of the second beam 210b reflected from the polarizing and filtering element 260 to reflect the second beam 210b from the polarizing and filtering element 260 toward the direction substantially the same as the direction of the second beam 210b passing through the filter 220. In other embodiments, the reflector 270 may be replaced by a polarizing beam splitter (PBS), and the PBS may also reflect the second beam 210b with the p-polarization direction from the polarizing and filtering element 260.

The first temperature adjuster 240 is connected with the filter 220 for adjusting the temperature of the filter 220. The second temperature adjuster 250 is connected with the nonlinear optical crystal 230 for adjusting the temperature of the nonlinear optical crystal 230. In the present embodiment, the first temperature adjuster 240 includes a first temperature sensor 242 and a first heater 244 electrically connected with the first temperature sensor 242. The filter 220 is connected with both the first temperature sensor 242 and the first heater 244. The second temperature adjuster 250 includes a second temperature sensor 252 and a second heater 254 electrically connected with the second temperature sensor 252. The nonlinear optical crystal 230 is connected with both the second temperature sensor 252 and the second heater 254. More particularly, the first and second temperature sensor 242 and 252 are, for example, thermistors or thermal couples.

In the laser module 200, the first and second temperature sensors 242 and 252 measure the temperatures of the filter 220 and the nonlinear optical crystal 230, respectively. When the temperature of the environment is changed, the first heater 244 heats the filter 220 or let the filter 220 cool down naturally according to the temperature data from the first temperature sensor 242, and the second heater 254 heats the nonlinear optical crystal 230 or let the nonlinear optical crystal 230 cool down naturally according to the temperature data from the second temperature sensor 252, so as to make the temperature of the nonlinear optical crystal 230 match the temperature of the filter 220, such that the wavelength and power of the second beam 210b output from the laser module 200 are kept substantially constant from changing with the temperature of the environment.

Moreover, when the duty cycle, gating, or output power of the light emitter 210 is changed, the temperature of the filter 220 may be changed with the variation of the light absorption quantity of the filter 220 if the first temperature adjuster 240 is not working, such that the transmission or absorption spectrum is changed, which makes the wavelengths of the second beam 210b and the reflected first beam 210a be changed and reduces the output power of the laser module 200 due to the temperature mismatch between the filter 220 and the nonlinear optical crystal 230. Therefore, when the first temperature adjuster 240 fixes the temperature of the filter 220 and the second temperature adjuster 240 adjusts the temperature of the nonlinear optical crystal 230 to the temperature matching the fixed temperature of the filter 220, the laser module 200 outputs the second beam 210b with a stable wavelength and with a power varied substantially linearly with the duty cycle, gating, or output power of the light emitter 210.

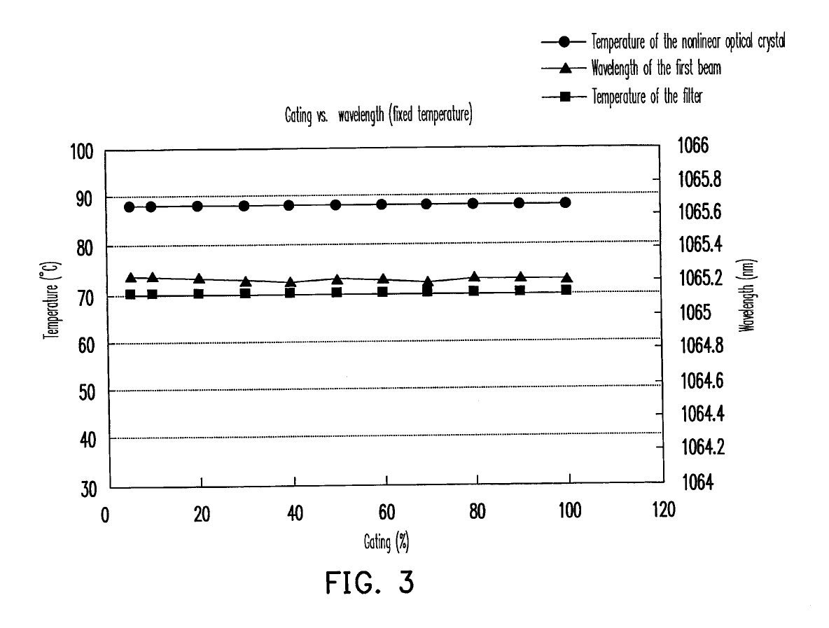

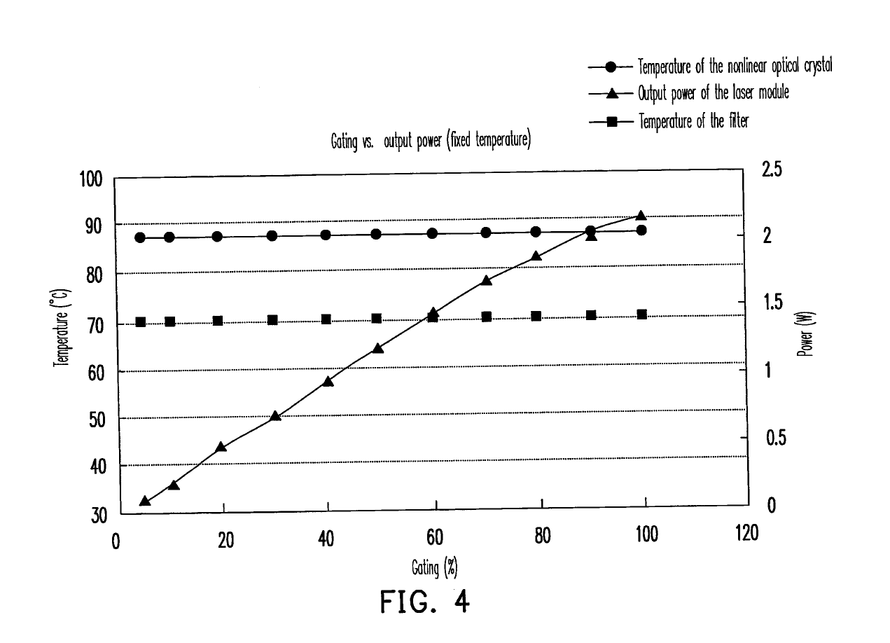

The experimental data to verify the above effect of the laser module 200 are shown in FIGS. 3 and 4, but they are not intended to limit the present invention. Anyone skilled in the art may suitably modify the parameters or settings after referring to the present invention, which is still considered as within the scope of the present invention.

Referring to FIGS. 2 and 3, the data in FIG. 3 show that the temperatures of the filter 220 and nonlinear optical crystal 230 are fixed, and the wavelength of the first beam 210a is fixed without changing with the gating of the light emitter 210. Referring to FIGS. 2 and 4, the data in FIG. 4 show that the temperatures of the filter 220 and nonlinear optical crystal 230 are fixed, and the output power of the laser module 200 is varied substantially linearly with the gating of the light emitter 210.

Additionally, when the laser module 200 is starting to work, the temperature of the nonlinear optical crystal 230 may not match the temperature of the filter 220. If there were only the second temperature adjuster 250 but not the first temperature adjuster 240 in the laser module 200, the output power of the laser module 200 could not reach a preferred value until the temperature of the nonlinear optical crystal 230 is adjusted to the temperature matching the temperature of the filter 240, which spends some time. Since the laser module 200 of the present embodiment includes both the first and second temperature adjuster 240 and 250 connected with the filter 220 and the nonlinear optical crystal 230, respectively, and since the first and second temperature adjuster 240 and 250 may work synchronously, the temperatures of the filter 223 and the nonlinear optical crystal 230 may match each other promptly through being adjusted by the first and second temperature adjusters 240 and 250 respectively after the laser module 200 starts to work. Therefore, the output power of the laser module 200 may reach the preferred value promptly after the laser module 200 starts to work.

It should be noted that, in other embodiments, the first heater 244 and the second heater 254 may also be replaced by a first thermal electrical cooler (TEC) and a second TEC, respectively. The first TEC is capable of heating or cooling the filter 220, and the second TEC is capable of heating or cooling the nonlinear optical crystal 230. The first and second TECs cool the filter 220 and the nonlinear optical crystal 230 rather than lets the filter 220 and the nonlinear optical crystal 230 cool down naturally, which makes the temperatures of the filter 220 and the nonlinear optical crystal 230 match each other faster.

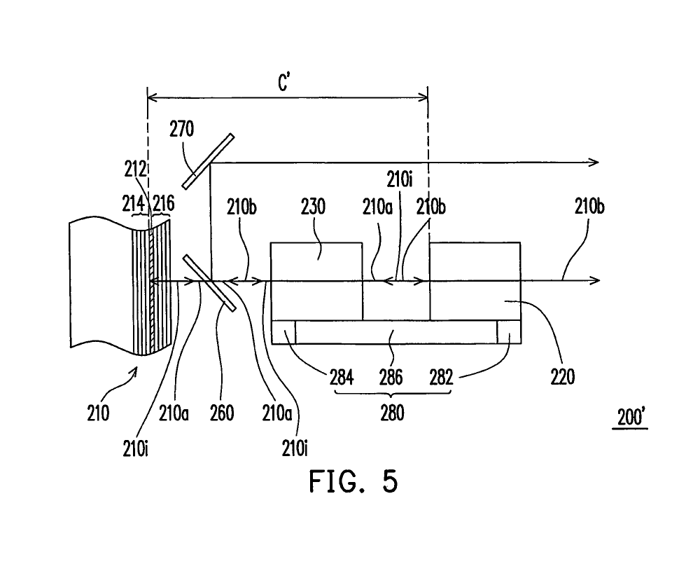

Referring to FIG. 5, a laser module 200′ according to another embodiment of the present invention is similar to the above laser module 200 shown in FIG. 2, except that the first and second temperature adjusters 240 and 250 in FIG. 2 are replaced by a single temperature adjuster 280 in the laser module 200′. The temperature adjuster 280 is connected with both the filter 220 and the nonlinear optical crystal 230 for adjusting temperatures of both the filter 220 and the nonlinear optical crystal 230. In the present embodiment, the temperature adjuster 280 includes a first temperature sensor 282, a second temperature sensor 284, and a heater 286. The first temperature sensor 282 is connected with the filter 220. The second temperature sensor 284 is connected with the nonlinear optical crystal 230. The heater 286 is electrically connected with both the first temperature sensor 282 and the second temperature sensor 284, and is connected with both the filter 220 and the nonlinear optical crystal 230. The laser module 200′ has similar advantages and effects as those of the above laser module 200 shown in FIG. 2.

It should be noted that the heater 286 in the laser module 200′ may also be replaced by a TEC in other embodiments.

Based on the above, in the laser module according to an embodiment of the present, when the temperature of the environment is changed, the temperatures of the filter and the nonlinear optical crystal are adjusted to match each other, such that the power of the second beam output from the laser module is kept substantially constant from changing with the temperature of the environment. Furthermore, the temperatures of the filter and the nonlinear optical crystal may be kept at specific values matching each other, such that the wavelength of the second beam output from the laser module is kept substantially constant from changing with the temperature of the environment.

Moreover, when the duty cycle, gating, or output power of the light emitter is changed, the temperatures of the filter and the nonlinear optical crystal are fixed to the values matching each other, such that the laser module outputs the second beam with a stable wavelength and with a power varied substantially linearly with the duty cycle, gating, or output power of the light emitter.

Additionally, since the temperatures of the filter and the nonlinear optical crystal may be adjusted synchronously to match each other after the laser module starts to work, the output power of the laser module may reach a preferred value promptly after the laser module starts to work.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A laser module comprising:
a light emitter capable of emitting an first beam;
a filter disposed on a transmission path of the first beam and capable of reflecting the first beam;
a nonlinear optical crystal disposed on the transmission path of the first beam and between the light emitter and the filter, wherein the nonlinear optical crystal is capable of converting a part of the first beam into a second beam, a frequency of the second beam is larger than a frequency of the first beam, and the filter is capable of being passed through by the second beam;
a polarizing and filtering element disposed on the transmission path of the first beam and between the light emitter and the nonlinear optical crystal, wherein the polarizing and filtering element is capable of being passed through by at least a part of the first beam with a specific polarization direction and reflecting the second beam;
a first temperature adjuster connected with the filter for adjusting a temperature of the filter; and
a second temperature adjuster connected with the nonlinear optical crystal for adjusting a temperature of the nonlinear optical crystal.

2. The laser module according to claim 1, wherein the light emitter comprises:
a light emitting layer capable of emitting the first beam;
a reflecting unit disposed on one side of the light emitting layer for reflecting the first beam; and
a partially transmitting and partially reflecting unit disposed on another side of the light emitting layer opposite to the reflecting unit and on the transmission path of the first beam between the light emitting layer and the nonlinear optical crystal.

3. The laser module according to claim 1, wherein the first temperature adjuster comprises a first temperature sensor and a first heater electrically connected with the first temperature sensor, the filter is connected with both the first temperature sensor and the first heater, the second temperature adjuster comprises a second temperature sensor and a second heater electrically connected with the second temperature sensor, and the nonlinear optical crystal is connected with both the second temperature sensor and the second heater.

4. The laser module according to claim 1, wherein the first temperature adjuster comprises a first temperature sensor and a first thermal electrical cooler electrically connected with the first temperature sensor, the filter is connected with both the first temperature sensor and the first thermal electrical cooler, the second temperature adjuster comprises a second temperature sensor and a second thermal electrical cooler electrically connected with the second temperature sensor, and the nonlinear optical crystal is connected with both the second temperature sensor and the second thermal electrical cooler.

5. The laser module according to claim 1, wherein the filter is a volume Bragg grating or a notch filter.

6. The laser module according to claim 1, wherein the frequency of the second beam is double the frequency of the first beam.

7. The laser module according to claim 1, further comprising a reflector disposed on a transmission path of the second beam reflected from the polarizing and filtering element.

8. The laser module according to claim 1, further comprising a polarizing beam splitter disposed on a transmission path of the second beam reflected from the polarizing and filtering element for reflecting the second beam with the specific polarization direction.

9. A laser module comprising:
a light emitter capable of emitting an first beam;
a filter disposed on a transmission path of the first beam and capable of reflecting the first beam;
a nonlinear optical crystal disposed on the transmission path of the first beam and between the light emitter and the filter, wherein the nonlinear optical crystal is capable of converting a part of the first beam into an second beam, a frequency of the second beam is larger than a frequency of the first beam, and the filter is capable of being passed through by the second beam;
a polarizing and filtering element disposed on the transmission path of the first beam and between the light emitter and the nonlinear optical crystal, wherein the polarizing and filtering element is capable of being passed through by at least a part of the first beam with a specific polarization direction and reflecting the second beam; and
a temperature adjuster connected with both the filter and the nonlinear optical crystal for adjusting temperatures of both the filter and the nonlinear optical crystal.

10. The laser module according to claim 9, wherein the light emitter comprises:
a light emitting layer capable of emitting the first beam;
a reflecting unit disposed on one side of the light emitting layer for reflecting the first beam; and
a partially transmitting and partially reflecting unit disposed on another side of the light emitting layer opposite to the reflecting unit and on the transmission path of the first beam between the light emitting layer and the nonlinear optical crystal.

11. The laser module according to claim 9, wherein the temperature adjuster comprises:
a first temperature sensor connected with the filter;
a second temperature sensor connected with the nonlinear optical crystal; and
a heater electrically connected with both the first temperature sensor and the second temperature sensor, and connected with both the filter and the nonlinear optical crystal.

12. The laser module according to claim 9, wherein the temperature adjuster comprises:
a first temperature sensor connected with the filter;
a second temperature sensor connected with the nonlinear optical crystal; and
a thermal electrical cooler electrically connected with both the first temperature sensor and the second temperature sensor, and connected with both the filter and both the nonlinear optical crystal.

13. The laser module according to claim 9, wherein the filter is a volume Bragg grating or a notch filter.

14. The laser module according to claim 9, wherein the frequency of the second beam is double the frequency of the first beam.

15. The laser module according to claim 9, further comprising a reflector disposed on a transmission path of the second beam reflected from the polarizing and filtering element.

16. The laser module according to claim 9, further comprising a polarizing beam splitter disposed on a transmission path of the second beam reflected from the polarizing and filtering element for reflecting the second beam with the specific polarization direction.
